(19) United States
(12) Patent Application Publication
(10) Pub. No.: US 2010/0203302 A1
(43) Pub. Date: Aug. 12, 2010

(54) COMPOSITE ELEMENT

(75) Inventor: Rainer Stricker, Gundelfingen (DE)

Correspondence Address: Briscoe, Kurt G.;Norris McLaughlin & Marcus, PA, 875 Third Avenue, 8th Floor, New York, NY, 10022, US

(73) Assignee: TESA SE, Hamburg (DE)

(21) Appl. No.: 12/672,539

(22) PCT Filed: Jul. 16, 2008
(86) PCT No.: PCT/EP2008/059310

§ 371 Date: Apr. 14, 2010

(30) Foreign Application Priority Data
Aug. 14, 2007 (DE) 10 2007 038 458.2

(51) Int. Cl. B32B 7/02; B32B 9/04; B32B 27/42; B32B 37/04

(52) U.S. Cl. 428/212; 428/411.1; 428/522; 156/182

(57) ABSTRACT

A composite element permanent connects two plastics elements. The composite element comprises a sheet with at least one adhesive mass that is initially non-adherent, and is permanently adherent after an activation process.

The present invention relates to a composite element for the permanent connection of two plastics elements, to a plastics housing with a corresponding composite element, and also to a process for the connection of two plastics elements.

It is known from the prior art that two plastics can be welded to one another to provide a permanent connection. However, the welding of plastics to one another is possible only in a limited range of circumstances, in particular specifically when plastics have relatively similar melting points. If the plastics to be connected to one another have melting points which differ markedly from one another, the welding process is problematic because the welding temperature has to correspond at least to the temperature of the higher of the two melting points. The plastic with the lower melting point is therefore subjected prematurely to a high level of thermal stress, and this can lead to undesired alterations at the joint.

A known alternative uses adhesive tape for the permanent connection of plastics elements. However, handling difficulties arise with adhesive tape. Specifically, the first attempt to position the plastics element and the adhesive tape has to be successful, because repositioning is difficult. One of the situations where adhesive tape is not suitable is therefore the connection of the plastics elements that form the housing of an airbag. Specifically, when the bag is inserted into the plastics housing there is at least a risk that the airbag will come into contact with the adhesive tape and adhere thereto.

The prior art (DE 10 2005 037 662 A1; DE 10 2005 037 663 A1) discloses the use of an adhesive tape, where a thermal welding procedure is first used to make a permanent adhesive connection between this and a polymeric substrate on one side, and between this and another piece of the same adhesive tape on the other side.

The problem addressed by the present invention is to provide a composite element for the permanent connection of two plastics elements, where the element is not only easy to handle but also can be used without restriction, in particular for a variety of plastics.

The present invention solves the problem explained above for a composite element with the features of the preamble of claim 1 by using the features of the characterizing part of claim 1, and for a plastics housing with the features of the preamble of claim 13 by using the features of the characterizing part of claim 13, and also by using a process for the connection of two plastics elements, according to claim 17. Respective dependent claims provide preferred embodiments.

The invention solves the problem in that the plastics elements are not, as has been usual hitherto, welded directly to one another, and no conventional adhesive tape is used for permanent connection of the same. Instead, the plastics elements to be connected are connected to one another by means of a composite element arranged between these. This composite element has been designed as a sheet, its area therefore being large in comparison with its thickness. The composite element also comprises an adhesive mass, which, however, is initially non-adherant. It is therefore possible to begin by repeatedly repositioning not only the plastics elements but also the composite element, without producing an adhesive connection which would then have to be broken for purposes of repositioning. The adhesive mass is then an adhesive mass that can be activated, i.e. that does not become tacky until it has undergone an activation procedure.

In principle, any desired thermal effect can be used to activate the adhesive mass. However, it has been found, in particular for the connection of plastics elements, that activation by an ultrasound welding process or a high-frequency welding process is particularly suitable. Specifically, the activation process can then take place substantially independently of temperature, thus allowing processing times to be reduced, and avoiding any need to subject the plastics elements that are to be connected to one another to any high temperatures that adversely affect the material.

In particular, ultrasound welding and high-frequency welding ensure that the thermal effect occurs with a maximum of localization to the composite element, thus permitting avoidance of any undesired alteration of the plastics elements at the joint. It is actually the composite element that provides the permanent connection between the two plastics elements, and it is therefore also possible to use this type of composite element to connect any desired different plastics to one another. In particular, the respective plastics elements can have different melting points, and in particular with a melting-point difference of up to 30° C., preferably of up to 50° C.

Ultrasound welding is a process for joining plastics. This process, without any appropriate connection element, can in principle only weld thermoplastics. As is the case with all other welding processes, the material has to be melted at the welding site by introducing heat. In the case of ultrasound welding, the required heat is generated by high-frequency mechanical vibration. The main feature of this process is that the heat required for the welding process is produced between the components through molecular and interfacial friction within the components. Ultrasound welding is therefore classified as frictional welding.

The ultrasound welding equipment required for this purpose consists essentially of the following modules:
generator
stack (sonotrode)
anvil

The generator is used to generate the ultrasound frequency, and converts the supply voltage to a high voltage and high frequency. A shielded cable transmits the electrical energy to an ultrasound converter. The converter uses the piezoelectric effect, which utilizes the property possessed by certain crystals of expanding and contracting when an alternating electric field is applied. This produces mechanical vibrations, which are transmitted to the sonotrode (the “welding horn”) by way of a booster. The booster can influence the amplitude of the vibration. The vibrations are transmitted under a pressure of from 2 to 5 N/mm² to a workpiece clamped between the sonotrode and an anvil, thus generating the heat required for plastification, through molecular and interfacial friction. The local temperature causes softening of the respective plastic or in the present case the composite element, and the coefficient of damping rises. The increase in the damping factor leads to further generation of heat, the resultant effect being that of a self-accelerating reaction. This process is characterized by very low welding times and therefore often by high cost-effectiveness.

After cooling, the welded connection is secure. The sonotrode is exposed to long periods of ultrasound vibration, and the requirements placed upon the material are therefore very high. Carbide-coated titanium is therefore mostly used.

In contrast, high-frequency welding is a pressure-welding process where heat is applied, generated by using the electrical resistance losses in the adherends. There are two variants of the use of HF electric current in welding technology: these introduce the energy by inductive and conductive methods. In the case of conductive HF welding, the energy is introduced by way of busbars or sliding contacts, whereas in the inductive variant it is introduced through an induction coil situated over the adherends. The high-frequency alternating current heats the connection site by virtue of electrodynamic effects on the adherends, and force is applied to interlock the parts with one another. The thermoplastics for welding have to have a dissipation factor d>0.01. HF welding which introduces the energy by an inductive method is currently used in industry mainly for producing pipes with a longitudinal seam.

In a preferred embodiment, the adhesive mass is an adhesive mass which can minimize processing times. In combination with the welding processes described above, the entire process of connection of the plastics elements can then take place very quickly and efficiently. Suitable adhesive masses have been found to permit processing times of less than 5 sec., preferably less than 2 sec., more preferably less than 1 sec., for the activation of the adhesive mass. These short activation times can by way of example be achieved with adhesive masses based on phenolic resin, in the case of ultrasound welding.

As a function of the respective properties required from the specific connection of the two plastics elements, various embodiments of the composite element can be further preferred, for example those in which the sheet comprises a support, or else has been designed so as not to comprise a support. A design which does not comprise a support, for example taking the form of a transfer adhesive tape with two different adhesive masses, or with only one adhesive mass, is useful if the intention is to minimize the overall height of the composite element, for example in the case of adhesive bonds in the miniaturized sector. In contrast to this, the design with an additional support is particularly advantageous by way of example if particularly high mechanical stability of the composite element itself is required, for example in the case of connections subject to high load, or else in order to improve capability for stamping when stamping parts are used in the form of composite element.

Phenolic-resin-based adhesive mass and/or adhesive masses based on nitrile rubber can in particular be used as adhesive mass for the composite element.

Examples of suitable nitrile-butadiene rubbers are obtainable as Europrene™ from Eni Chem, or as Krynac™ and Perbunan™ from Bayer, or as Breon™ and Nipol N™ from Zeon. Hydrogenated nitrile-butadiene rubbers are obtainable as Therban™ from Bayer and as Zetpol™ from Zeon. Nitrile-butadiene rubbers are polymerized in either high- or low-temperature processes.

In one preferred embodiment of the invention, the acrylonitrile content of the nitrile rubbers is from 15 to 45%. In order to avoid complete phase separation when using the reactive resins, acrylonitrile contents should be greater than 15%, again based on total content. Another criterion for the nitrile rubber is Mooney viscosity. High flexibility at low temperatures has to be provided, and Mooney viscosity should therefore be below 100 (Mooney ML 1+4 at 100° C.). A commercial example of a nitrile rubber of this type is Nipol™ N917 from Zeon Chemicals.

Carboxy-, amine-, epoxy-, or methacrylate-terminated nitrile-butadiene rubbers can be used as additional components. The molar mass of these elastomers is particularly preferably M_{w}<20 000 g/mol and their acrylonitrile content is particularly preferably from 5% to 30%. In order to achieve ideal miscibility, the acrylonitrile content should at least be greater than 5%, again based on total elastomer content. A commercial example of this type of terminated nitrile rubber is Hycar™ from Noveon.

For carboxy-terminated nitrile-butadiene rubbers it is preferable to use rubbers having a carboxylic acid number of from 15 to 45, very preferably from 20 to 40. The carboxylic acid number is stated as a value in milligrams of KOH needed for complete neutralization of the carboxylic acid.

For amine-terminated nitrile-butadiene rubbers it is particularly preferable to use rubbers having an amine value of from 25 to 150, more preferably from 30 to 125. The amine value is based on the amine equivalents determined by titration against HCl in ethanolic solution. The amine value here is based on amine equivalents per 100 grams of rubber, finally divided by 100.

The content of the reactive resins in the activatable adhesive mass is from 75 to 30% by weight. One very preferred group comprises epoxy resins. The molar mass M_{w} of the epoxy resins varies from 100 g/mol up to a maximum of 10000 g/mol for polymeric epoxy resins.

The epoxy resins comprise by way of example the reaction product of bisphenol A and epichlorohydrin, epichlorohydrin, glycidyl ester, and the reaction product of epichlorohydrin and p-aminophenol.

Preferred commercial examples are Araldite™ 6010, CY-281™, ECN™ 1273, ECN™ 1280, MY 720, RD-2 from Ciba Geigy, DER™ 331, DER™ 732, DER™ 736, DEN™ 432, DEN™ 438, DEN™ 485 from Dow Chemical, Epon™ 812, 825, 826, 828, 830, 834, 836, 871, 872, 1001, 1004, 1031 etc., from Shell Chemical, and HPT™ 1071, HPT™ 1079 likewise from Shell Chemical.

Examples of commercial aliphatic epoxy resins are vinylcyclohexane dioxides, such as ERL-4206, ERL-4221, ERL 4201, ERL-4289 or ERL-0400 from Union Carbide Corp.

Examples of novolak resins that can be used are Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DaiNipon Ink Chemistry, or Epicote™ 152 from Shell Chemical.

Other reactive resins that can also be used are melamine resins, e.g. Cymel™ 327 and 323 from Cytec.

Other reactive resins that can also be used are terpene-phenolic resins, e.g. NIREZ™ 2019 from Arizona Chemical.

In another preferred embodiment, other reactive resins that can also be used are phenolic resins, e.g. YP 50 from Toto Kasei, PKHC from Union Carbide Corp., and BKR 2620 from Showa Union Gosei Corp. Other reactive resins that can also be used are phenolic-resol resins, which can also be used in combination with other phenolic resins.

Other reactive resins that can also be used are polyisocyanates, e.g. Coronate™ L from Nippon Polyurethan Ind., Desmodur™ N3300, or Mondur™ 489 from Bayer.

In one advantageous embodiment of the activatable adhesive mass, (tackifier) resins that increase adhesion are also added, a very advantageous proportion being up to 30% by weight, based on the entire mixture of the activatable adhesive mass. Tackifier resins that can be added are absolutely any of the adhesive resins that are previously known and described in the literature. Examples that may be mentioned are the pinene, indene, and colophony resins and their disproportionated, hydrogenated, polymerized, or esterified derivatives and salts, the aliphatic and aromatic hydrocarbon resins, terpene resins and terpene-phenol resins, and also C5 and C9 hydrocarbon resins, and also other hydrocarbon resins. It is possible to use any desired combination of these and other resins in order to adjust the properties of the resultant adhesive mass as desired. It is generally possible to use any of the resins that are compatible with (soluble in) the nitrile rubbers, and particular reference may be made to any of the aliphatic, aromatic, alkylaromatic hydrocarbon resins, hydrocarbon resins based on pure monomers, hydrogenated hydrocarbon resins, functional hydrocarbon resins, and also natural resins. A reference that may be expressly mentioned is “Handbook of Pressure Sensitive Adhesive Technology” from Donatas Satas (van Nostrand, 1989), which describes the extent of knowledge then available.

Optional addition of crosslinking agents and accelerators to the mixture is also possible, in order to accelerate the reaction between the two components.

Examples of suitable accelerators are imidazoles, obtainable commercially as 2M7, 2E4MN, 2PZ-CN, 2PZ-CNS, P0505, L07N from Shikoku Chem. Corp., or Curezol 2MZ from Air Products. HMTA (hexamethylenetetramine) is another suitable crosslinking agent that can be added.

Amines can also be used for acceleration, in particular tertiary amines.

Plasticizers can also be used, alongside reactive resins. In one preferred embodiment of the invention, plasticizers based on polyglycol ethers, on polyethylene oxides, or on phosphate esters can be used here, as also can aliphatic carboxylic acid esters and benzoic esters. It is also possible to use aromatic carboxylic esters, and relatively high-molecular-weight diols, sulfonamides, and adipic esters.

Other materials that can optionally be added are fillers (e.g. silica, silicates, fibers, carbon black, zinc oxide, titanium dioxide, chalk, solid or hollow glass beads, or microbeads made of other materials), nucleating agents, blowing agents, adhesion-increasing additives, and thermoplastics, compounding agents, and/or aging stabilizers, e.g. in the form of primary and secondary antioxidants or in the form of light stabilizers.

In one preferred embodiment, further additives are added, examples being polyvinyl formal, polyacrylate rubbers, chloroprene rubbers, ethylene-propylene-diene rubbers, methyl vinyl silicone rubbers, fluorosilicone rubbers, tetrafluoroethylene-propylene copolymer rubbers, butyl rubbers, and styrene-butadiene rubbers.

Polyvinyl butyrals are obtainable as Butvar™ from Solucia, as Pioloform™ from Wacker and as Mowital™ from Kuraray. Polyacrylate rubbers are obtainable as Nipol AR™ from Zeon. Chloroprene rubbers are obtainable as Baypren™ from Bayer. Ethylene-propylene-diene rubbers are obtainable as Keltan™ from DSM, as Vistalon™ from Exxon Mobile, and as Buna EP™ from Bayer. Methyl vinyl silicone rubbers are obtainable as Silastic™ from Dow Corning, and as Silopren™ from GE Silicones. Fluorosilicone rubbers are obtainable as Silastic™ from GE Silicones. Butyl rubbers are obtainable as Esso Buryl™ from Exxon Mobil. Styrene-butadiene rubbers are obtainable as Buna S™ from Bayer, and Europrene™ from Eni Chem, and as Polysar S™ from Bayer.

Polyvinyl formals are obtainable as Formvar™ from Ladd Research.

In another preferred embodiment, examples of the additives added are thermoplastic materials from the group of the following polymers: polyurethanes, polystyrene, acrylonitrile-butadiene-styrene terpolymers, polyesters, rigid polyvinyl chlorides, flexible polyvinyl chlorides, polyoxymethylenes, polybutylene terephthalates, polycarbonates, fluorinated polymers, e.g. polytetrafluoroethylene, polyamides, ethylene-vinyl acetates, polyvinyl acetates, polyimides, polyethers, copolyamides, copolyesters, polyolefins, e.g. polyethylene, polypropylene, polybutene and polyisobutene, and poly(meth)acrylates.

The adhesion of the activatable adhesive mass can be raised by using other specific additive systems. Examples of additions that increase adhesion are also polyimine copolymers and polyvinyl acetate copolymers.

However, the activatable adhesive mass can also receive admixtures of thermoplastic materials. The thermoplastic materials are preferably selected from the group of the following polymers: polyurethanes, polyesters, polyamides, ethylene-vinyl acetates, synthetic rubbers, e.g. styrene-isoprene di- and triblock copolymers (SIS), styrene-butadiene di- and triblock copolymers (SBS), styrene-ethylene-butadiene di- and triblock copolymer (SEGS), polyvinyl acetate, polyimides, polyethers, copolyamides, copolyesters, polyolefins, e.g. polyethylene and polypropylene, or poly(meth)acrylates, and it is also possible to use mixtures of these. The list does not claim to be comprehensive.

In another embodiment of the invention, thermoplastic blends are selected from a polymer group, and the polymers here then have different chemical constitution.

In order to optimize technical adhesion properties and activation range, it is optionally possible to add adhesion-increasing resins or reactive resins. The proportion of the resins is from 2 to 50% by weight, based on the thermoplastic material.

Tackifier resins, reactive resins or additives that can be used are any of the abovementioned systems that can be used to optimize the nitrile rubber formulations.

It is also possible to use acrylate-based activatable adhesive masses. In one particularly preferred embodiment, the activatable adhesive masses are then composed of a main polymer a) composed of
a1) from 40 to 95% by weight of acrylate and/or methacrylate having the following formula

CH₂═CH(R₁)(COOR₂),
where R₁═H and/or CH₃, and R₂═H and/or alkyl chains having from 1 to 30 carbon atoms,
a2) from 5 to 30% by weight of a copolymerizable vinyl monomer having at least one carboxylic acid and/or sulfonic acid and/or phosphonic acid group,
a3) from 1 to 10% by weight of a copolymerizable vinyl monomer having at least one epoxy group or one anhydride function,
a4) from 0 to 20% by weight of a copolymerizable vinyl monomer which, by using the functional group, can contribute to an increase in cohesion, to an increase in crosslinking reactivity, or to direct crosslinking,
   and
b) from 5 to 50% by weight of an epoxy resin or of a mixture made of a plurality of epoxy resins.

The polymer a) can comprise an activatable pressure-sensitive adhesive mass which develops tack as a consequence of temperature and optional pressure and which generates high adhesion via the solidification process after adhesive-bonding and cooling. As a function of usage temperature, said activatable pressure-sensitive adhesive masses have different static glass transition temperatures T_{G,A} or melting points T_{S,A}.

In one very preferred embodiment, the monomers al) used comprise acrylic monomers which comprise acrylates and methacrylates having alkyl groups composed of from 4 to 14 carbon atoms, preferably from 4 to 9 carbon atoms. Specific examples, without any intention that this list be restrictive, are n-butyl acrylate, n-pentyl acrylate, n-hexyl acrylate, n-heptyl acrylate, n-octyl acrylate, n-nonyl acrylate, lauryl acrylate, stearyl acrylate, behenyl acrylate, and the branched isomers of these, e.g. 2-ethylhexyl acrylate. Other classes of compound to be used which can likewise be added in small amounts within c1) are methyl methacrylates, cyclohexyl methacrylates, isobornyl acrylate, and isobornyl methacrylates.

Monomers a2) used preferably comprise itaconic acid, acrylic acid, methacrylic acid, vinylacetic acid, fumaric acid, crotonic acid, aconitic acid, dimethylacrylic acid, β-acryloyloxypropionic acid, trichloroacrylic acid, vinylphosphonic acid, vinylsulfonic acid, and vinylsulfonic acid.

Monomers a3) preferably used comprise glycidyl methacrylate, maleic anhydride, and itaconic anhydride.

In one very preferred embodiment, the monomers a4) used comprise vinyl esters, vinyl ethers, vinyl halides, vinylidene halides, and vinyl compounds having aromatic rings and having heterocyclic rings, in α-position. Here again, mention may be made of some non-exclusive examples: vinyl acetate, vinylformamide, vinylpyridine, ethyl vinyl ether, vinyl chloride, vinylidene chloride, and acrylonitrile. In another very preferred embodiment of the monomers a4), monomers having the following functional groups are used: hydroxyl groups, amide groups, isocyanato groups, or amino groups.

Other particularly preferred examples of component a4) are hydroxyethyl acrylate, hydroxypropyl acrylate, hydroxyethyl methacrylate, hydroxypropyl methacrylate, allyl alcohol, acrylamide, benzyl acrylate, benzyl methacrylate, phenyl acrylate, phenyl methacrylate, tert-butylphenyl acrylate, tert-butylphenyl methacrylate, phenoxyethyl acrylate, phenoxyethyl methacrylate, 2-butoxyethyl methacrylate, 2-butoxyethyl acrylate, dimethylaminoethyl methacrylate, dimethylaminoethyl acrylate, diethylaminoethyl methacrylate, diethylaminoethyl acrylate, cyanoethyl methacrylate, cyanoethyl acrylate, 6-hydroxyhexyl methacrylate, N-tert-butylacrylamide, N-methylolmethacrylamide, N-(butoxymethyl)methacrylamide, N-methylolacrylamide, N-(ethoxymethyl)acrylamide, N-isopropylacrylamide, and tetrahydrofurfuryl acrylate, this list being non-exclusive.

In another preferred embodiment, the component a4) used comprises aromatic vinyl compounds where the aromatic rings are preferably composed of C₄ to C₁₈, with the additional possibility of the presence of heteroatoms. Particularly preferred examples are styrene, 4-vinylpyridine, N-vinylphthalimide, methylstyrene, 3,4-dimethoxystyrene, and 4-vinylbenzoic acid, this being a non-exclusive list.

For the polymerization reaction, the monomers are in turn selected in such a way that the resultant polymers can be used industrially as pressure-sensitive or other adhesive masses, and are in particular selected in such a way that the resultant polymers have adherent or pressure-sensitive-adherent properties in accordance with “Handbook of Pressure Sensitive Adhesive Technology” by Donatas Satas (van Nostrand, New York 1989). Here again, the glass transition temperature can be controlled as desired by applying the Fox equation (E1) during formulation of the monomer mixture used in the polymerization reaction. The static glass transition temperature of the resultant polymer is advantageously below 15° C. for pressure-sensitive adhesive masses.

In accordance with the above, in order to achieve a glass transition temperature T_{G,A}≧30° C. for the polymers for a heat-activatable adhesive mass, the selection of the monomers and the quantitative constitution of the monomer mixture are very preferably and advantageously selected in such a way as to give the desired T_{G,A} value for the polymer in the Fox equation (E1) (cf. T. G. Fox, Bull. Am. Phys. Soc. 1 (1956) 123).

$$\frac{1}{{T}_{G}} = {\sum }_{n} \frac{{W}_{n}}{{T}_{G , n}} \qquad ( E1 )$$

In this equation, n represents the serial number of the monomers used, wₙ represents the quantitative proportion of the respective monomer n (% by weight), and T_{G,n} represents the respective glass transition temperature of the homopolymer made of the respective monomers n, in K.

The adhesive masses are advantageously produced by conventional free-radical polymerization reactions or controlled free-radical polymerization reactions. For the free-radical polymerization reactions it is preferable to use initiator systems which additionally comprise further free-radical initiators for the polymerization reaction, particularly azo or peroxo initiators which generate free radicals and which decompose thermally. However, in principle any of the conventional initiators familiar to the person skilled in the art for use with arylates is suitable. The production of C-centered free radicals is described in Houben Weyl, Methoden der Organischen Chemie [Methods of Organic Chemistry], vol. E 19a, pp. 60-147. It is preferable to use methods analogous to these.

Examples of free-radical sources are peroxides, hydroperoxides, and azo compounds, and some non-exclusive examples that may be mentioned here of typical free-radical initiators are potassium peroxodisulfate, dibenzoyl peroxide, cumene hydroperoxide, cyclohexanone peroxide, di-tert-butyl peroxide, azodiisobutyronitrile, cyclohexylsulfonyl acetyl peroxide, diisopropyl percarbonate, tert-butyl peroctoate, and benzopinacol. In one very preferred embodiment, the free-radical initiator used comprises 1,1′-azobis(cyclohexane carbonitrile) (Vazo 88™ from DuPont).

The average molar masses Mₙ of the pressure-sensitive adhesive masses produced during the free-radical polymerization reaction are very preferably selected such that they lie within a range from 20 000 to 2 000 000 g/mol; specifically for further use as pressure-sensitive hot-melt adhesives, pressure-sensitive adhesive masses are produced with average molar masses Mₙ of from 100 000 to 500 000 g/mol. The average molar mass is determined by size-exclusion chromatography (SEC) or matrix-assisted laser desorption/ionization mass spectrometry (MALDI-MS).

The polymerization reaction can be carried out in bulk, in the presence of one or more organic solvents, in the presence of water, or in a mixture of organic solvents and water. It is desirable here to minimize the amount of solvent used. Suitable organic solvents are pure alkanes (e.g. hexane, heptane, octane, isooctane), aromatic hydrocarbons (e.g. benzene, toluene, xylene), esters (e.g. ethyl acetate, or propyl, butyl, or hexyl acetate), halogenated hydrocarbons (e.g. chlorobenzene), alkanols (e.g. methanol, ethanol, ethylene glycol, ethylene glycol monomethyl ether), and ethers (e.g. diethyl ether, dibutyl ether), or a mixture thereof. A water-miscible or hydrophilic cosolvent can be admixed with the aqueous polymerization reactions, in order to ensure that the reaction mixture takes the form of a homogeneous phase during reaction of the monomer. Cosolvents that can be used with advantage for the present invention are selected from the following group: aliphatic alcohols, glycols, ethers, glycol ethers, pyrrolidines, N-alkylpyrrolidinones, N-alkylpyrrolidinones, polyethylene glycols, polypropylene glycols, amides, carboxylic acids, and salts thereof, esters, organosulfides, sulfoxides, sulfones, alcohol derivatives, hydroxyether derivatives, aminoalcohols, ketones, and the like, and also derivatives and mixtures thereof.

The polymerization time is—as a function of conversion and temperature—from 4 to 72 hours. The higher the reaction temperature that can be selected, i.e. the higher the thermal stability of the reaction mixture, the lower the reaction time that can be selected.

For the initiators that decompose thermally, supply of heat is essential in order to initiate the polymerization reaction. In the case of the initiators that decompose thermally, the polymerization reaction can be initiated by heating to from 50 to 160° C., as a function of initiator type.

An advantageous procedure for free-radical stabilization uses nitroxides of type (NIT 1) or (NIT 2):

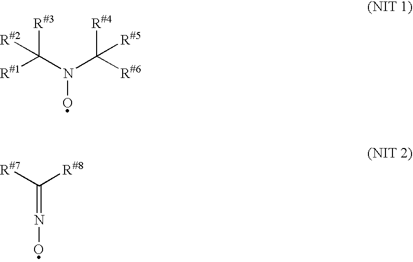

where R^{#1}, R^{#}, R^{#3}, R^{#4}, R^{#5}, R^{#6}, R^{#7}, and R^{#8} are, independently of one another, the following compounds or atoms:
i) halides, e.g. chlorine, bromine, or iodine,
ii) linear, branched, cyclic, and heterocyclic hydrocarbons having from 1 to 20 carbon atoms, where these may be saturated, unsaturated, or aromatic systems, and
iii) esters —COOR^{#9}, alkoxides —OR^{#10}, and/or phosphonates —PO(OR^{#11})₂, where R^{#9}, R^{#10}, and/or R^{#11} are moieties from the group ii).

Compounds of the structure (NIT 1) or (NIT 2) can also have been bonded to polymer chains of any type (predominantly in the sense that at least one of the abovementioned moieties is this polymer chain), and they can thus be utilized as macroradicals or macroregulators for constructing block copolymers.

Further preference is given to controlled regulators for the polymerization reaction involving compounds of the following type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-tert-butyl-PROXYL, 3,4-di-tert-butyl-PROXYL,
2,2,6,6-tetramethyl-1-piperidinyloxylpyrrolidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl,
N-tert-butyl-1-phenyl-2-methylpropyl nitroxide,
N-tert-butyl-1-(2-naphthyl)-2-methylpropyl nitroxide,
N-tert-butyl-1-diethylphosphono-2,2-dimethylpropyl nitroxide,
N-tert-butyl-1-dibenzylphosphono-2,2-dimethylpropyl nitroxide,
N-(1-phenyl-2-methylpropyl)-1-diethylphosphono-1-methylethyl nitroxide,
di-tert-butyl nitroxide,
diphenyl nitroxide,
tert-butyl-tert-amyl nitroxide.

A number of other polymerization methods that can be used to produce the lamination adhesive masses by an alternative procedure can be selected from the prior art:

U.S. Pat. No. 4,581,492 A discloses a controlled free-radical polymerization process using a compound of the formula R′R″N—O—Y as initiator, in which Y is a free-radical species which can polymerize unsaturated monomers. However, the conversions of the reactions are generally low. Polymerization of acrylates is particularly problematic, giving only very low yields and molar masses. WO 98/13392 A1 describes open-chain alkoxyamine compounds which have a symmetrical substitution pattern. EP 735 052 A1 discloses a process for the production of thermoplastic elastomers with narrow molar mass distributions. WO 96/24620 A1 describes a polymerization process using very specific free-radical compounds, e.g. phosphorus-containing nitroxides, based on imidazolidine. WO 98/44008 A1 discloses specific nitroxyls, based on morpholines, piperazinones, and piperazinediones. DE 199 49 352 A1 describes heterocyclic alkoxyamines as regulators in controlled-free-radical polymerization reactions. Appropriate refinements of the alkoxyamines and, respectively, the corresponding free nitroxides improve efficiency for the production of polyacrylates (Hawker, Paper given at the General Meeting of the American Chemical Society, Spring, 1997; Husemann, Paper given at IUPAC World-Polymer Meeting 1998, Gold Coast).

Another controlled polymerization method that can be used advantageously for the synthesis of the block copolymers is Atom Transfer Radical Polymerization (ATRP), where the initiator used preferably comprises monofunctional or difunctional secondary or tertiary halides and, for abstraction of the halide(s), complexes of Cu, of Ni, of Fe, of Pd, of Pt, of Ru, of Os, of Rh, of Co, of Ir, of Ag, or of Au (EP 0 824 111 A1; EP 826 698 A1; EP 824 110 A1; EP 841 346 A1; EP 850 957 A1). The various possibilities of ATRP are also described in the following specifications: U.S. Pat. No. 5,945,491 A, U.S. Pat. No. 5,854,364 A, and U.S. Pat. No. 5,789,487 A.

Preference is further given to an anionic polymerization reaction for advantageous production of the polymer employed according to the invention. Here, the reaction medium used preferably comprises inert solvents, e.g. aliphatic and cycloaliphatic hydrocarbons, or else aromatic hydrocarbons.

The living polymer is generally represented by the structure P_{L}(A)-Me, where Me is a metal of group I of the Periodic Table of the Elements, e.g. lithium, sodium, or potassium, and P_{L}(A) is a growing polymer block made of the monomers [a1)-a4)]. The molar mass of the polymer to be produced is prescribed via the ratio of initiator concentration to monomer concentration.

An example of a suitable polymerization initiator is n-propyllithium, n-butyllithium, sec-butyllithium, 2-naphthyllithium, cyclohexyllithium, or octyllithium, but this list does not claim to be comprehensive. Initiators based on samarium complexes are also known for the polymerization of acrylates (Macromolecules, 1995, 28, 7886), and can be used here.

It is also possible to use difunctional initiators, examples being 1,1,4,4-tetraphenyl-1,4-dilithiobutane or 1,1,4,4-tetraphenyl-1,4-dilithioisobutane. Coinitiators can likewise be used. Suitable coinitiators are inter alia lithium halides, alkali metal alkoxides, or alkylaluminum compounds. In one very preferred variant, the selection of the ligands and coinitiators is such as to permit direct polymerization of acrylate monomers such as n-butyl acrylate and 2-ethylhexyl acrylate, without any need for these to be generated within the polymer via transesterification with the corresponding alcohol.

A variant of the RAFT polymerization reaction (reversible addition-fragmentation chain transfer polymerization) is a very preferred production process. The polymerization process is described in detail by way of example in the specifications WO 98/01478 A1 and WO 99/31144 A1. Trithiocarbonates of the general structure R′″—S—C(S)—S—R′″ (Macromolecules 2000, 33, 243-245) are particularly advantageously suitable for the production process.

In one very advantageous variant, for example trithiocarbonates (TTC1) and (TTC2) or thio compounds (THI1) and (THI2) are used for the polymerization reaction, where φ can be a phenyl ring, which can be an unfunctionalized ring or can be a ring functionalized via alkyl or aryl substituents linked directly or by way of ester bridges or by way of ether bridges, or can be a cyano group, or can be a saturated or unsaturated aliphatic moiety. The phenyl ring φ can optionally bear one or more polymer blocks, for example polybutadiene, polyisoprene, polychloroprene, or poly(meth)acrylate, where this can have a structure in accordance with the definition of P(A) or P(B), or polystyrene, to mention just a few possibilities. Examples of functionalizing moieties can be halogens, hydroxy groups, epoxy groups, nitrogen-containing groups, or sulfur-containing groups; this list does not claim to be comprehensive.

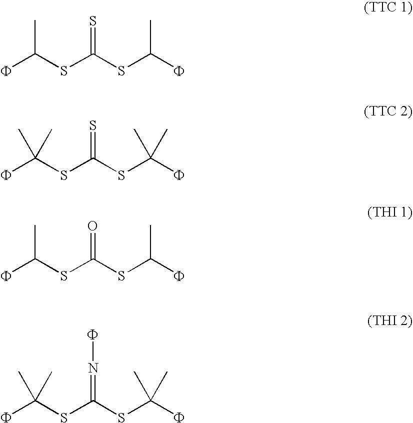

### Thioesters of the General Structure

R^{$1}—C(S)—S—R^{$2} (THE)

can moreover be used, in particular, in order to produce asymmetrical systems. R^{$1} and R^{$2} here can be selected independently of one another, and R^{$1} can be a moiety from one of the following groups i) to iv), and R^{$2} can be a moiety from one of the following groups i) to iii):
i) to C₁₈-alkyl, C₂- to C₁₈-alkenyl, C₂- to C₁₈-alkynyl, in each case linear or branched; aryl, phenyl, benzyl, and aliphatic and aromatic heterocyclic systems,
ii) —NH₂, —NH—R^{$3}, —NR^{$3}R^{$4}, —NH—C(O)—R^{$3}, —NR^{$3}—C(O)—R^{$4}, —NH—C(S)—R^{$3}—NR^{$3}—C(S)—R^{$4},

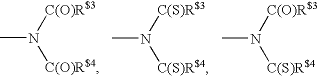

where R^{$3} and R^{$4} are moieties selected independently of one another from the group i),
(iii) —S—R^{$5}, —S—C(S)—R^{$5}, where R^{$5} can be a moiety from one of the groups i) and ii),
(iv) —O—R^{$6}, —O—C(O)—R^{$6}, where R^{$6} can be a moiety selected from one of the groups i) and ii).

Initiator systems preferred in conjunction with the abovementioned polymerization reactions that proceed by a controlled free-radical mechanism are those which additionally comprise further free-radical initiators for the polymerization reaction, in particular free-radical-generating azo or peroxo initiators that decompose thermally. However, in principle any of the known conventional initiators for acrylates is suitable for this purpose. The production of C-centered free radicals is described in Houben-Weyl, Methoden der Organischen Chemie [Methods of Organic Chemistry], vol. E19a, pp. 60ff. These methods are used with preference. Examples of free-radical sources are peroxides, hydroperoxides, and azo compounds. Some non-exclusive examples that may be mentioned of typical free-radical initiators are: potassium peroxodisulfate, dibenzoyl peroxide, cumene hydroperoxide, cyclohexanone peroxide, cyclohexylsulfonyl acetyl peroxide, di-tert-butyl peroxide, azodiisobutyronitrile, diisopropyl percarbonate, tert-butyl peroctoate, and benzopinacol. In one very preferred variant, the free-radical initiator used comprises 1,1′-azobis(cyclohexylnitrile) (Vazo 88®, DuPont®) or 2,2-azobis(2-methylbutanonitrile) (Vazo 67®, DuPont®). It is also possible to use free-radical sources which do not release free radicals until they are subject to UV irradiation.

The conventional RAFT process mostly polymerizes only as far as low conversions (WO 98/01478 A1), in order to maximize the narrowness of molecular weight distributions. However, because the conversions are low, these polymers cannot be used as pressure-sensitive adhesive masses and in particular not as pressure-sensitive hot-melt adhesives, since the high proportion of residual monomers has an adverse effect on technical adhesive properties, the residual monomers contaminate the recycled solvent during the process of concentration, and the corresponding self-adhesive tapes would exhibit a very high level of gassing.

The epoxy resins described comprise the entire group of the epoxy compounds. The epoxy resins can therefore be monomers, oligomers, or polymers. Polymeric epoxy resins can be of aliphatic, cycloaliphatic, aromatic, or heterocyclic type. The epoxy resins preferably have at least two epoxy groups which can be employed for the crosslinking process.

The molar mass of the epoxy resins varies from 100 g/mol up to a maximum of 25 000 g/mol for polymeric epoxy resins.

The epoxy resins comprise by way of example the reaction product of bisphenol A and epichlorohydrin, the reaction product of phenol and formaldehyde (novolak resins) and epichlorohydrin, and glycidyl ester, and the reaction product of epichlorohydrin and p-aminophenol.

Examples of preferred commercial products are Araldite™ 6010, CY-281™, ECN™ 1273, ECN™ 1280, MY 720, RD-2 from Ciba Geigy, DER™ 331, DER™ 732, DER™ 736, DEN™ 432, DEN™ 438, DEN™ 485 from Dow Chemical, Epon™ 812, 825, 826, 828, 830, 834, 836, 871, 872, 1001, 1004, 1031, etc. from Shell Chemical, and HPT™ 1071, HPT™ 1079, likewise from Shell Chemical.

Examples of commercial aliphatic epoxy resins are vinylcyclohexane dioxides, such as ERL-4206, ERL-4221, ERL 4021, ERL-4289, or ERL-0400 from Union Carbide Corp.

In one possible embodiment, the adhesive mass comprises further formulation constituents, e.g. fillers, pigments, rheology additives, additives for improving adhesion, plasticizers, elastomers, aging stabilizers (antioxidants), light stabilizers, UV absorbers, or else other auxiliaries and additives, e.g. desiccants (e.g. molecular sieve zeolites, calcium oxide), flow agents and flow-control agents, wetting agents (surfactants), or catalysts.

The fillers used can comprise any of the finely ground solid additives such as chalk, magnesium carbonate, zinc carbonate, kaolin, barium sulfate, titanium dioxide, or calcium oxide. Further examples are talc, mica, silica, silicates, or zinc oxide. Mixtures of the substances mentioned can also be used.

The pigments used can be of organic or inorganic type. It is possible to use any of the types of organic or inorganic color pigments, examples being white pigments such as titanium dioxide, for improving resistance to light and to UV, and also metal pigments.

Examples of rheology additives are fumed silicas, phyllosilicates (bentonites), high-molecular weight polyamide powders, or castor-oil-derivative powders.

Additives for improving adhesion can by way of example be substances from the groups of the polyamides, epoxides, or silanes.

Examples of plasticizers are phthalates, trimellitates, phosphates, adipates, and also other acyclic dicarboxylic esters, fatty acid esters, hydroxycarboxylic esters, and phenyl alkylsulfonates, aliphatic, cycloaliphatic, and aromatic mineral oils, hydrocarbons, liquid or semi-solid rubbers (e.g. nitrile rubbers or polyisoprene rubbers), liquid or semi-solid polymers of butane and/or isobutene, acrylates, polyvinyl ethers, and the liquid and plasticizing resins based on raw materials that are also the raw materials used for tackifier resins; other examples are wool wax and other waxes, silicones, and also polymeric plasticizers, such as polyesters or polyurethanes.

Suitable resins are any of the natural and synthetic resins, e.g. colophony derivatives (e.g. derivatives produced via disproportionation, hydrogenation, or esterification), cumarone-indene resins and polyterpene resins, aliphatic or aromatic hydrocarbon resins (C-5, C-9, (C-5)₂ resins), mixed C-5/C-9 resins, hydrogenated and partially hydrogenated derivatives of these types, resins made of styrene or α-methylstyrene, and also terpene-phenol resins and other resins as listed in Ullmanns Enzyklopädie der technischen Chemie [Ullmann's Encylopedia of Industrial Chemistry], volume 12, pp. 525-555 (4th edn.), Weinheim.

Examples of suitable elastomers are EPDM rubber or EPM rubber, polyisobutylene, butyl rubber, ethylene-vinyl acetate, hydrogenated block copolymers of dienes (e.g. obtained by hydrogenation of SBR, cSBR, BAN, NBR, SBS, SIS, or IR, polymers of this type being known as, for example, SEPS and SEBS), or acrylate copolymers, such as ACM.

The prior art also includes formulation of the adhesive mass with further constituents, e.g. fillers and plasticizers.

A further aspect of the present invention consists in the use of the composite element described above for the permanent connection of two plastics elements, in particular made of different plastics. This use gives a particularly effective and simple method of achieving permanent connection between plastics elements, while avoiding any damage to the plastics elements themselves during the connection process.

Finally, the object is achieved via a process for the connection of two plastics elements, in particular for the production of a plastics housing, by means of a composite element, in particular one as described above. In said process, a composite element designed as a sheet is used and comprises at least one adhesive mass, which is initially non-adherent. Said composite element is arranged between the plastics elements to be connected. The adhesive mass is not activated until the composite element, and also the two plastics elements, have been arranged in the desired position. The activation of the adhesive mass here produces a permanent connection between the plastics elements. In comparison with welding processes without use of a composite element, the advantage of the process of the invention is that alterations in the plastics elements at the joint can be reduced or entirely avoided. Compared to the use of conventional adhesive tapes, the positioning of the plastics elements and of the composite element itself, and hence the overall handling, are simplified considerably. Nevertheless, a permanent bond is achieved, which also withstands relatively large stress forces.

It is also advantageous in this context that two plastics elements made of different plastics can be bonded to one another. The composite element serves as a buffer which compensates for any temperature difference between the plastics elements to be bonded and hence reduces the change in structure in the plastics elements.

The activation of the adhesive mass can be achieved in a particularly simple manner by means of an ultrasound welding process or a high-frequency welding process. In particular, welding procedures of this type permit activation of the adhesive mass within very short processing times. By way of example, processing times of less than 5 sec. are possible. It is preferable that the activation of the adhesive mass is achieved within a processing time of less than 2 sec., more preferably less than 1 sec.

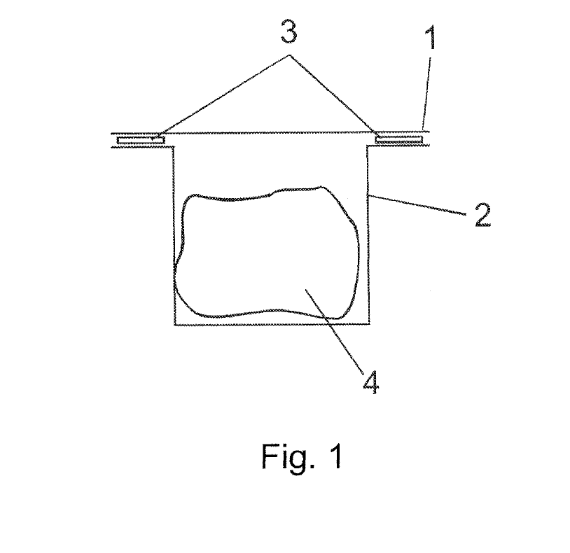

Further details, features, objectives, and advantages of the present invention are explained in more detail below by using a drawing of a preferred embodiment. The drawing in FIG. 1 shows a schematic diagram of an exploded view of a plastics housing with a composite element of the invention.

FIG. 1 shows a plastics housing, in this case the housing of an airbag. The plastics housing comprises two plastics elements 1, 2 and a composite element 3. The composite element 3 has been arranged between the two plastics elements 1, 2, and connects the two plastics elements 1, 2 permanently to one another. Within the plastics housing formed from the two plastics elements 1, 2, there is an airbag 4 included, which is in particular drawn into the plastics housing by use of subatmospheric pressure. In the present embodiment, the airbag can be arranged without difficulty within the plastics housing. In particular, when the airbag 4 is introduced there is no risk that it becomes adhesive-bonded to the composite element 3, since the composite element 3 is not activated until a later juncture.

To this end, the composite element 3 has been designed as a sheet with at least one adhesive mass. However, this adhesive mass is initially non-adherent. The adhesive mass does not become tacky until it has undergone an activation process. In the condition shown here, the two plastics elements 1, 2 have already been permanently connected to one another via the composite element 3, and the adhesive mass has already been activated, and from now on is permanently adherent.

The two plastics elements 1, 2 here are composed of different plastics. Plastics element 1 is namely composed of HDPE, and plastics element 2 of PA6GF40, i.e. of polyamide with 40% glassfiber content. The composite element 3 therefore permits permanent connection of different plastics. It is also significant here that the controlled activation of the adhesive mass can reduce or entirely avoid the occurrence of alterations in the plastics elements 1, 2 at the joint. The alterations that occur at the joint in a conventional welding procedure without composite element, or in a non-specific heating process, would therefore generally be markedly greater, unless appropriate precautions of some other type were taken.

Permanent connection of the two plastics elements 1, 2 has been achieved here via activation of a composite element 3 by means of an ultrasound welding process. For this, a temperature of about 55-60° C. has been set at the sonotrode during a long period of operation, and the frequency is 50 Hz. With the parameters thus adjusted, a processing time of less than 1 second could be achieved for the activation of the composite element 3, using the present materials. The plastics housing could withstand full loading after only a short period of cooling to room temperature.

1. A composite element for the permanent connection of two plastics elements, the composite element comprising a sheet with at least one adhesive mass, that the adhesive mass is initially non-adherent, and that the adhesive mass is permanently adherent after an activation process.

2. The composite element according to claim 1, wherein the adhesive mass fuses with plastic by virtue of the activation process.

3. The composite element according to claim 1, wherein the adhesive mass is activated by means of ultrasound welding and/or high-frequency welding.

4. The composite element according to claim 1, wherein the adhesive mass is activated within a processing time of less than 5 seconds.

5. The composite element according to claim 1, wherein the adhesive mass withstands a load immediately after cooling to room temperature.

6. The composite element according to claim 1, wherein the sheet does not comprise a support.

7. The composite element according to claim 1, wherein the sheet comprises a permanent support.

8. The composite element according to claim 1, wherein the adhesive mass has high adhesion to plastic.

9. The composite element according to claim 1, wherein the adhesive mass is adapted to provide permanent connection between plastic elements, wherein the plastic elements are made of plastics that differ from one another.

10. The composite element according to claim 9, wherein the adhesive mass has been designed to provide a permanent connection between plastics elements made of different plastics having different melting points, wherein the different plastics have a melting-point difference of up to 50° C.

11. The composite element according to claim 1, wherein the adhesive mass is a phenolic-resin-based adhesive mass.

12. The composite element according to claim 1, wherein the adhesive mass is based on a nitrile rubber.

13. A plastics housing with two plastics elements and with a composite element, wherein the composite element is located between the plastics elements, wherein the two plastics elements have been connected permanently to one another by means of the composite element, wherein the composite element comprises a sheet with at least one adhesive mass, wherein the adhesive mass is initially non-adherent and does not become permanently adherant until an activation process has occurred.

14. The plastics housing according to claim 13, wherein the two plastics elements are composed of plastics that differ from one another.

15. The plastics housing according to claim 14, wherein the two plastics have melting points that differ from one another, wherein the two plastics have a melting-point difference of up to 50° C.

16. The plastics housing according to claim 13, wherein the composite element has been designed according to claim 1.

17. A process for the connection of two plastics elements for the production of a plastics housing, by means of a composite element according to claim 1 wherein the composite element has been designed as a sheet with at least one adhesive mass, wherein the adhesive mass is initially non-adherant, wherein the composite element is arranged between the plastics elements and wherein the adhesive mass is activated and the plastics elements are thus permanently connected to one another by means of the composite element.

18. The process according to claim 17, wherein the two plastics elements are made of plastics that differ from one another and are connected to one another, wherein the two plastic elements have different melting points, wherein the two plastic elements have melting-point difference of up to 50° C.

19. The process according to claim 17, wherein activation of the adhesive mass is achieved by means of an ultrasound welding process and/or a high-frequency welding process.

20. The process according to claim 17, wherein activation of the adhesive mass takes place within a processing time of less than 5 seconds.

21. The process according to claim 17, wherein the plastics elements do not experience alteration at the joint.
